(19) United States
(12) Patent Application Publication
(10) Pub. No.: US 2025/0337334 A1
(43) Pub. Date: Oct. 30, 2025

(54) SWITCHED-MODE CONVERTER

(71) Applicants: Commissariat à l'Energie Atomique et aux Energies Alternatives, Paris (FR); RENAULT SAS, BOULOGNE BILLANCOURT (FR)

(72) Inventors: Xavier MAYNARD, Grenoble (FR); Sylvain LEIRENS, Grenoble (FR); Serge LOUDOT, Villiers Le Bacle (FR)

(21) Appl. No.: 18/860,301

(22) PCT Filed: Apr. 25, 2023
(86) PCT No.: PCT/EP2023/060712

§ 371 Date: Oct. 25, 2024

(30) Foreign Application Priority Data
Apr. 26, 2022 (FR) FR2203871

(51) Int. Cl. H02M 3/335; H02M 1/00; H02M 1/12; H02M 1/44

(52) U.S. Cl. CPC H02M 3/33584; H02M 1/0058; H02M 1/123; H02M 1/44; H02M 3/33573

(57) ABSTRACT

The present disclosure relates to a switching supply system including at least a pair of dual-bridge converters (DAB1, DAB2), wherein: first H-bridge switches of the converters are coupled, in parallel or series, to two terminals (12, 14) for applying a first voltage (Vin), second H-bridge switches of the converters being coupled, in parallel or series, to two terminals (16, 18) for supplying a second voltage (Vout), and the switches of the converters (DAB1, DAB2) are controlled in opposition from one converter to the other.

### FIELD

The present invention relates generally to electronic systems and more particularly to switched-mode converters.

### BACKGROUND

Switched-mode converters are widely used in electronics to convert one voltage into another of different value (higher or lower) and/or different nature (AC or DC). Depending on the application, a switched-mode converter can be DC-DC (Direct Current-Direct Current), AC-AC (Alternating Current-Alternating Current), DC-AC, or AC-DC. There are many different topologies for switched-mode converters, differing in particular in the nature of the galvanic isolation element (coupled inductors, transformers, etc.) and the arrangement of the switching switch(es) (series, single-bridge, dual-bridge, H-bridge, etc.).

Document EP 3 817 207 describes dual-active-bridge systems for cancelling oscillations.

Document WO 2019/158118 describes a power converter with a wide DC voltage range.

Document CN 112803740 describes a method and system for soft-starting a DC transformer with series inputs and parallel outputs.

Document WO 2019/158567 describes a dual-active-bridge DC-DC converter with a wide operating range.

Document “Research on Loss Reduction of Dual Active Bridge Converter Over Wide Load Range for Solid State Transformer Application” by Qingsham Wang et al., 2016 Eleventh International Conference on Ecological Vehicles and Renewable Energies, XP032903389, describes noise reduction techniques for dual-active-bridge converters.

Document “Review of de-de converters for multi-terminal HVDC transmission networks” by Adam Grain Philip et al., IET POWER ELECTRONICS, IET, UK, XP006055530, describes DC-DC converters for HVDC transmission networks.

### SUMMARY

There is a need to improve known converters.

There is a need for a DC-DC switched-mode converter allowing an operation at high switching frequencies.

There is a need for a switched-mode converter causing low electromagnetic interference.

One embodiment overcomes some or all drawbacks of known switched-mode converters.

Switching power supply system including:
two dual-active-bridge converters;
a first switch set coupling two terminals for applying a first voltage to both input terminals of each converter, or to a single input terminal of each converter respectively;
a second switch set coupling two terminals for supplying a second voltage to both output terminals of each converter, or to a single output terminal of each converter respectively; and
a circuit controlling the switches of the first and second sets,
the switches of the converters being controlled in opposition from one converter to the other.

According to one embodiment, the switches of the second set are controlled according to the desired value of the second voltage.

According to one embodiment, the switches of the first set are controlled as a function of the required power output.

According to one embodiment:
a first input terminal of the first converter is coupled to a first terminal for applying a first voltage and, via a first switch of the first set, to a first input terminal of the second converter;
a second input terminal of the first converter is coupled, via a second switch of the first set, to the second terminal for applying the first voltage or to the first input terminal of the second converter;
a first output terminal of the first converter is coupled to a first terminal for supplying a second voltage and, via a first switch of the second set, to a first output terminal of the second converter; and
a second output terminal of the first converter is coupled, via a second switch of the second set, to a second terminal for supplying the second voltage or to the first output terminal of the second converter.

One embodiment provides a switching power supply system including at least one pair of dual-bridge converters, wherein:
first H-bridges of switches of the converters are coupled, in parallel or in series, to two terminals for applying a first voltage,
second H-bridges of switches of the converters are coupled, in parallel or in series, to two terminals for supplying a second voltage, and
the switches of the converters are controlled in opposition from one converter to the other.

According to one embodiment, each converter comprises:
a first H-bridge including a first and a second parallel arm of two switches in series between the two input terminals of the converter;
a second H-bridge including a third and a fourth parallel arm of two switches in series between the two output terminals of the converter;
a transformer, a first winding of which is coupled to the respective interconnection nodes of the series switches of the first and second arms, and a second winding of which is coupled to the respective interconnection nodes of the series switches of the third and fourth arms.

According to one embodiment, four inductive elements are respectively interposed between each winding end and the interconnection node to which this end is coupled.

According to one embodiment, said inductive elements all have the same value.

According to one embodiment, each H-bridge includes:
a first switch and a second switch in series within the first arm;
a third switch and a fourth switch in series within the second arm;
a fifth switch and a sixth switch in series within the third arm;
a seventh switch and an eighth switch in series within the fourth arm.

According to one embodiment:
the first switch of each converter is turn conductive, respectively blocked, at the same time as the second switch of the other converter;
the third switch of each converter is turned conductive, respectively blocked, at the same time as the fourth switch of the other converter;
the fifth switch of each converter is turned conductive, respectively blocked, at the same time as the sixth switch of the other converter;
the seventh switch of each converter is turned conductive, respectively blocked, at the same time as the eighth switch of the other converter.

According to one embodiment, the transformer ratio of the transformers of the first and second converters is equal to 1.

According to one embodiment, the input terminals of both converters are common or interconnected.

According to one embodiment, both output terminals of both converters are common or interconnected.

According to one embodiment:
a first output terminal of a first converter is coupled, preferably connected, to a first terminal for supplying the second voltage;
a second output terminal of the first converter is coupled, preferably connected, to a first output terminal of a second converter; and
a second output terminal of the second converter is coupled, preferably connected, to a second terminal for supplying the second voltage.

According to one embodiment:
a first input terminal of a first converter is coupled, preferably connected, to a first terminal for applying the first voltage;
a second input terminal of the first converter is coupled, preferably connected, to a first input terminal of a second converter; and
a second input terminal of the second converter is coupled, preferably connected, to a second terminal for applying the first voltage.

According to one embodiment, switches are HEMT-type transistors in GaN technology.

According to one embodiment, switches are controlled at a switching frequency of several hundred kHz, preferably greater than 400 kHz.

According to one embodiment, the system includes a single pair of converters, and the first voltage is supplied by a circuit for rectifying a single-phase AC voltage.

According to one embodiment, the system includes three pairs of converters, and the first voltage of each converter is extracted based on rectifiying a three-phase AC supply.

According to one embodiment, the second voltage is intended for charging a battery, preferably a motor vehicle battery.

### BRIEF DESCRIPTION OF THE DRAWINGS

The foregoing features and advantages, as well as others, will be described in detail in the following description of specific embodiments given by way of illustration and not limitation with reference to the accompanying drawings, in which:

FIG. 1 illustrates very schematically an embodiment of a dual-active-bridge converter;

FIG. 2 illustrates very schematically and in block form, an embodiment of a conversion system;

FIG. 3 illustrates very schematically an example configuration of the system shown in FIG. 2 in a parallel input/parallel output connection;

FIG. 4, FIG. 5, FIG. 6, FIG. 7, and FIG. 8 illustrate, in chronogram form, the operation of a conversion system of the type shown in FIG. 3;

FIG. 9 illustrates, very schematically, an example configuration of the system shown in FIG. 2 in a parallel input/serial output connection;

FIG. 10 illustrates, very schematically, an example configuration of the system shown in FIG. 2 in a serial input/parallel output connection; and

FIG. 11 illustrates, very schematically, an example configuration of the system shown in FIG. 2 in a serial input/serial output connection.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For the sake of clarity, only the operations and elements that are useful for an understanding of the embodiments described herein have been illustrated and described in detail. In particular, the circuits for generating the control signals of the conversion system described have not been described in detail, as the embodiments described are compatible with the use of conventional circuits. Likewise, the equipment coupled to the input and output of the conversion system described have not been described in detail, the embodiments described being, again, compatible with the equipment usually coupled to the input and output of a switched-mode converter.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following disclosure, unless indicated otherwise, when reference is made to absolute positional qualifiers, such as the terms “front”, “back”, “top”, “bottom”, “left”, “right”, etc., or to relative positional qualifiers, such as the terms “above”, “below”, “higher”, “lower”, etc., or to qualifiers of orientation, such as “horizontal”, “vertical”, etc., reference is made to the orientation shown in the figures.

Unless specified otherwise, the expressions “around”, “approximately”, “substantially” and “in the order of” signify within 10%, and preferably within 5%.

The embodiments described are based on the use of dual-active-bridge-type DC-DC switched-mode converters. Such converters consist of two H-bridges with controllable switches, on either side of a transformer, for example associated with filter inductors.

In such converters, the aim is generally to switch zero voltage switching (ZVS), i.e. to switch bridge switches from blocked to conductive when the voltage across them is zero or close to zero. This allows energy losses in the switches to be reduced. On the other hand, the use of asymmetrical control (the controls of each arm are not opposed), introduces significant common-mode currents, particularly when switching switches coupled to grounds on the primary and secondary side of the transformer. Such common-mode currents are detrimental to the performance of the converter in terms of conducted electromagnetic interference, and all the greater the higher the switching frequency. As a result, the switching frequency is generally limited to the order of a hundred kHz, and the compactness of the transformer and inductive filters is therefore limited.

In order to reduce electromagnetic interference, switched-mode converters are generally combined with common-mode filters at the input and output so as to reduce conducted interference. The higher the power and the higher the frequency to be filtered, the more cumbersome and costly such filters become.

The emergence of High Electron Mobility Transistors (HEMTs), especially in Gallium Nitride (GaN), and Wide-Band Gap Transistors (WBGTs), which offer higher switching performance than metal-oxide semiconductor field-effect transistors (MOSFETs), has led to a desire to increase the switching frequencies of switched-mode converters in order to increase their power density.

According to the embodiments described, a conversion system is provided including two or a multiple of two dual-active-bridge converters the inputs and outputs of which are coupled, via switch sets, to terminals for applying a voltage to be converted, and for supplying a converted voltage. In other words, two dual-active-bridge converters are used, the inputs and outputs of which are arranged so that, from outside, two input terminals receive the voltage to be converted, and two output terminals supply the converted voltage. In addition, is provided a control of the switches of one converter in opposition to those of the other. This is equivalent to inverting the transistors of the arms to which same control signals are applied, from one converter to the other.

The inventors realized that by so combining and controlling two converters in the same conversion system, common-mode noise was considerably reduced, even at high frequencies (several hundred kHz). It's a bit like creating compensation between the noise generated by both converters.

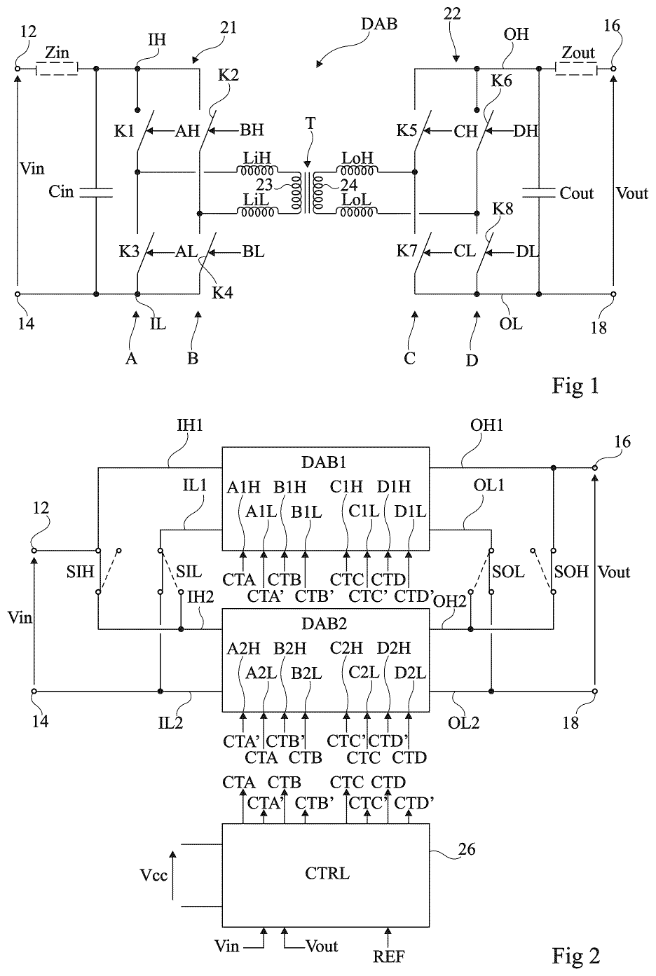

FIG. 1 illustrates very schematically an embodiment of a dual-active-bridge converter DAB.

In the example shown, the converter DAB receives a voltage Vin, and supplies a voltage Vout. The voltages Vin and Vout are DC voltages, in the context of the use of the converters made in the embodiments described.

Voltage Vin is applied between two input terminals 12 and 14, and voltage Vout is supplied between two output terminals 16 and 18.

The input voltage Vin can be, as will be seen later, a rectified voltage from an AC voltage power source, such as the mains or an alternator. This voltage is applied across a filter capacitor Cin, connected to input terminals IH and IL of a first H-bridge 21 of the dual bridge DAB. In FIG. 1, an input impedance Zin between terminals 12 and IH is shown as a dotted line. This impedance represents, for example, the equivalent impedance of circuits connected upstream of bridge 21.

Input bridge 21 includes two parallel arms, or branches, A and B, each including two switches in series, K1 and K3, K2 and K4 respectively, between terminals IH and IL. The midpoint (interconnection node) between switches K1 and K3 of arm A is coupled, for example and optionally by a resistive and/or inductive and/or capacitive (RLC) impedance, symbolized by its inductance LiH, to a first terminal of a primary winding 23 of a transformer T the other terminal of which is coupled, for example and optionally by an RLC impedance, symbolized by its inductance LiL, to the midpoint (interconnection node) between switches K2 and K4 of arm B.

The output voltage Vout is a rectified voltage intended, for example, for charging a vehicle battery. The voltage Vout is taken across a storage capacitor Cout, connected to output terminals OH and OL of a second H-bridge 22 of the dual-bridge DAB. In FIG. 1, an output impedance Zout between terminals OH and 16 is shown as a dotted line. This impedance represents, for example, the equivalent impedance (resistive and/or capacitive and/or inductive—RLC) of the circuits connected downstream of bridge 22.

Output bridge 22 includes two parallel arms, or branches, C and D, each including two switches in series, K5 and K7, K6 and K8 respectively, between the terminals OH and OL. The midpoint (interconnection node) between switches K5 and K7 of arm C is coupled, for example and optionally by an impedance RLC, symbolized by its inductance LoH, to a first terminal of a secondary winding 24 of transformer T the other terminal of which is coupled, for example and optionally by an impedance RLC, symbolized by its inductance LoL, to the midpoint (interconnection node) between switches K6 and K8 of arm D.

The transformer ratio of transformer T is, for example, unity, but can also be different from unity to add a variable to the ratio between the voltages Vout and Vin.

Each switch K1, K2, K3, K4, K5, K6, K7, K8 consists of a transistor. According to one embodiment, the switches K1, K2, K3, K4, K5, K6, K7, K8 are MOSFET transistors. According to another preferred example embodiment, the switches K1, K2, K3, K4, K5, K6, K7, K8 are HEMT transistors, preferably in GaN technology.

The operation of a dual-active-bridge converter as shown in FIG. 1 is in itself well known. Switches K1, K2, K3, K4, K5, K6, K7, and K8 receive on-off control signals (digital signals supplied, for example, by a microcontroller), AH, BH, AL, BL, CH, DH, CL, and DL respectively, which are adapted to the application and to the power drawn by the load (not illustrated) connected downstream of the converter. As previously mentioned, the bridge control is configured so that switching of the respective switches takes place in the vicinity of their zero voltage. Switching is also organized in such a way that simultaneous conduction of the two switches on the same arm are avoided.

The pulse control of a converter of the type illustrated in FIG. 1 is generally phase-shifted between the respective openings and closings of the upstream (input) and downstream (output) H-bridges, so as to ensure energy transfer while taking into account a power setpoint. The phase shifts introduced help to increase common-mode noise.

FIG. 2 illustrates very schematically and in block form, an embodiment of a conversion system.

According to this embodiment, two dual-active-bridge converters DAB1 and DAB2 of the converter DAB type illustrated in FIG. 1 are combined in an interleaved fashion. By interleaved, we mean that the respective H-bridges of both converters DAB1 and DAB2 are associated in series or in parallel, but that the two-converter conversion system includes only two input terminals 12 and 14 and two output terminals 16 and 18.

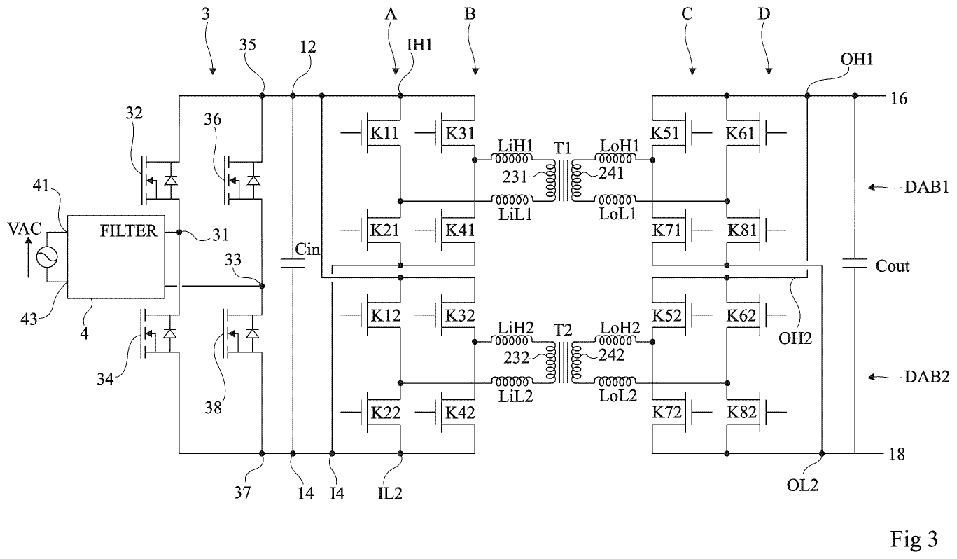

According to the embodiment described in relation to FIG. 2, a parameterizable conversion system is provided in which the series or parallel connection at the input and output is achieved by sets of configuration switches. In practice, and as will be seen in relation to FIGS. 3 and 9 to 11, the parallel or series connection of the input bridges of both converters and the parallel or series connection of the output bridges of both converters is selected, preferably automatically by a microcontroller-type control circuit, as a function of the input and output voltages and powers. For example, in the case of an electric vehicle recharging system, this enables, as will be detailed later, the same charging station to adapt automatically to the voltage required by a vehicle connected to it.

For simplicity, the internal structure of each converter is not illustrated in FIG. 2. Only the power input and output terminals connected via series-parallel switch sets SIH, SIL, respectively SOH, SOL, to terminals 12, 14 and 16, 18 respectively, as well as the control terminals of the bridge switches, are illustrated. Control terminals A1H, A1L, B1H, B1L, C1H, C1L, D1H, D1L, correspond to terminals AH, AL, BH, BL, CH, CL, DH, DL (FIG. 1) of the first converter DAB1. Control terminals A2H, A2L, B2H, B2L, C2H, C2L, D2H, D2L, correspond to terminals AH, AL, BH, BL, CH, CL, DH, DL (FIG. 1) of the second converter DAB2.

For parallel connection of the input bridges of both converters DAB1 and DAB2, their respective input terminals IH1 and IH2 (arbitrarily designated high inputs) are coupled to terminal 12, and their respective input terminals IL1 and IL2 (arbitrarily designated low inputs) are coupled to terminal 14. In FIG. 2, this corresponds to the solid-line position of the switches SIH and SIL.

For series connection of the input bridges of both converters, the high input terminal IH1 of the converter DAB1 is coupled, preferably connected, to terminal 12. The low input terminal IL1 of converter DAB1 is coupled, preferably connected, to the high input terminal IH2 of converter DAB2. The low input terminal IL2 of the converter DAB2 is coupled, preferably connected, to terminal 14. In FIG. 2, this corresponds to the dotted-line position of switches SIH and SIL.

For parallel connection of the output bridges of both converters DAB1 and DAB2, their respective output terminals OH1 and OH2 (arbitrarily designated high outputs) are coupled to terminal 16, and their respective output terminals OL1 and OL2 (arbitrarily designated low outputs) are coupled to terminal 18. In FIG. 2, this corresponds to the solid-line position of the switches SOH and SOL.

For series connection of the output bridges of both converters DAB1 and DAB2, the high output terminal OH1 of the converter DAB1 is coupled, preferably connected, to terminal 16. The low output terminal OL1 of the converter DAB1 is coupled, preferably connected, to the high output terminal OH2 of the converter DAB2. The low output terminal OL2 of the converter DAB2 is coupled, preferably connected, to terminal 18. In FIG. 2, this corresponds to the dotted-line position of the switches SOH and SOL.

Controlling the switches of converters DAB1 and DAB2 is provided by a circuit 26, e.g. a microcontroller, which adapts the respective closing and opening periods of the switches (the duty cycle of the control signals). Circuit 26 supplies control signals CTA, CTA′, CTB, CTB′, CTC, CTC′, CTD, and CTD′ intended to the switches of converters DAB1 and DB2. Circuit 2 is supplied with a low voltage (of the order of a few volts) Vcc. Preferably, circuit 26 also supplies control signals to the switch sets SIH, SIL and SOH, SOL.

One difference between switch control signals is that switches SIH, SIL, SOH, SOL are statically controlled, i.e. they remain in the same position for given voltages and powers, whereas bridge switches are dynamically controlled (at a frequency above 100 kHz).

Depending on the application, the duty cycle of the control signals CTA, CTA′, CTB, CTB′, CTC, CTC′, CTD, and CTD′ is preferably fixed, but can be variable. In the case of a variable ratio, the duty cycles remain identical in pairs (e.g. CTA, CTA′) to maintain opposing control. The circuit 26 then receives, for example, information REF relative to a desired output voltage value Vout and relative to the input voltage value Vin, and information relative to the output voltage Vout, so as to be able to dynamically adapt the control of the switches in the bridges accordingly.

In the embodiment illustrated in FIG. 2, the transistors to which the control signals are applied, are inverted from one converter to the next, arm by arm. Thus, signals CTA, CTB, CTC, and CTD are applied to control terminals A1H, B1H, C1H, D1H of the transistors of converter DAB1 and to control terminals A2L, B2L, C2L, D2L of converter DAB2, while the signals CTA′, CTB′, CTC′, and CTD′ are applied to the control terminals A1L, B1L, C1L, D1L of the transistors of converter DAB1 and to the control terminals A2H, B2H, C2H, D2H of the converter DAB2.

One advantage of the described conversion system is already apparent, namely that it requires no modification of the control circuit compared with a circuit designed for a dual-active-bridge converter of the type illustrated in FIG. 1. The system described is therefore easily transposable to existing conversion systems.

Providing common signals for the converters DAB1 and DAB2 is a preferred and straightforward embodiment. Alternatively, one could provide that the circuit 26 generates eight signals for the converter DAB1 and eight signals for the converter DAB2 separately, provided that these signals meet the condition of inverting the signals between the low transistors of one bridge with respect to the high transistors of the other bridge.

Preferably, the control signals CTA, CTA′, CTB, CTB′, CTC, CTC′, CTD, and CTD′ all have a duty cycle of the order of 50%.

According to another example embodiment, the converters DAB1 and DAB2 are controlled by pulse-width modulation depending on the requirements of the downstream-connected load and to the power available at the input. According to another example, control is performed by pulse frequency modulation. Both above examples could of course be combined.

The parallel/serial input and output configuration of the converters in the system shown in FIG. 2 depends on the application and, in particular, on component (especially switches) sizing and voltage levels

One advantage of the described solution is that, by providing the converters in parallel or in series, and by providing reverse control of one converter with respect to the other, high-frequency common-mode currents (above 100 kHz) are reduced at the parasitic capacitor level, linked to the switching of bridge switches.

One advantage of the solution described, in which the values of the inductive elements LiH, LiL, LoH, and LoL coupling the H-bridges of each converter to the transformer of that converter are identical, is that it reduces low-frequency (below kHz) common-mode currents, particularly associated with alternations of the AC voltage from which the voltage Vin is generated.

FIG. 3 illustrates very schematically an example configuration of the system shown in FIG. 2 in a parallel input/parallel output connection. For simplicity, the switch sets SIH, SIL, SOH, and SOL are not illustrated in FIG. 3.

In the example shown in FIG. 3, the conversion system is completed by a controllable full-wave bridge rectifier 3, two AC input terminals 31 and 33 of which are coupled, via a common-mode filter 4, to two terminals 41 and 43 for applying an AC voltage VAC, for example, the voltage of mains, and two rectified output terminals 35 and 37 of which are coupled, preferably connected, to the input terminals 12 and 14 of a dual converter of the type illustrated in FIG. 2.

The rectifier bridge 3 can be any rectifier bridge suitable for the application in question. In the example illustrated, bridge 3 includes two branches, each including two MOSFET transistors, 32 and 34, 36 and 38 respectively, in series between terminals 35 and 37. The midpoint between transistors 32 and 34 is coupled, preferably connected, to terminal 31. The midpoint between transistors 36 and 38 is coupled, preferably connected, to terminal 33. Compared with the dual inverter, the bridge rectifier 3 is controlled at a much lower frequency, depending on the frequency of the voltage VAC. The bridge rectifier can be controlled by pulse width modulation, depending on the power to be transmitted. The control signals applied to the gates of transistors 32, 34, 36, and 38 are, for example, provided by the microcontroller-type control circuit 26 (FIG. 2).

On the dual active H-bridge converter side, we find the architecture illustrated in FIG. 2, with converters DAB1 and DAB2 being connected in parallel on the input and output sides. The switches are illustrated as transistors.

The respective transistors of the converters DAB1 and DAB2 shown in FIG. 3 are designated by references corresponding to those used for the switches shown in FIG. 1, with the addition of “1” or “2” depending on whether the converter DAB1 or DAB2 is involved.

Thus, for the converter DAB1, the transistors are respectively K11 (control terminal A1H) and K31 (control terminal A1L) for the arm A, K21 (control terminal B1H) and K41 (control terminal B1L) for the arm B, K51 (control terminal C1H) and K71 (control terminal C1L) for the arm C, K61 (control terminal D1H) and K81 (control terminal D1L) for the arm D. The primary winding 231 of the transformer T1 of the converter DAB1 is associated with the primary series inductances LiH1, LiL1, and the secondary winding 241 is associated with the secondary series inductances LoH1, LoL1.

For the converter DAB2, the transistors are respectively K12 (control terminal A2H) and K32 (control terminal A2L) for the arm A, K22 (control terminal B2H) and K42 (control terminal B2L) for the arm B, K52 (control terminal C2H) and K72 (control terminal C2L) for the arm C, K62 (control terminal D2H) and K82 (control terminal D2L) for the arm D. The primary winding 232 of transformer T2 of the converter DAB2 is associated with the primary series inductances LiH2, LiL2, and the secondary winding 242 of transformer T2 is associated with the secondary series inductances LoH2, LoL2.

As both converters DAB1 and DAB2 are in parallel at input and output, they share the same input capacitance Cin and the same output capacitance Cout. With reference to FIG. 2, and assuming that the respective capacitances of the converters DAB1 and DAB2 are contained within the blocks, this means that the capacitance Cin shown in FIG. 3 corresponds to the parallel association of the input capacitances of the converters DAB1 and DAB2 shown in FIG. 2, and the capacitance Cout shown in FIG. 3 corresponds to the parallel association of the output capacitances of the converters DAB1 and DAB2 shown in FIG. 2.

Compared with a converter of the type shown in FIG. 1, an advantage of the parallel/parallel system shown in FIG. 2 is that, for given powers or voltages, the components (in particular the transistors forming the switches) can be sized for a lower power/voltage.

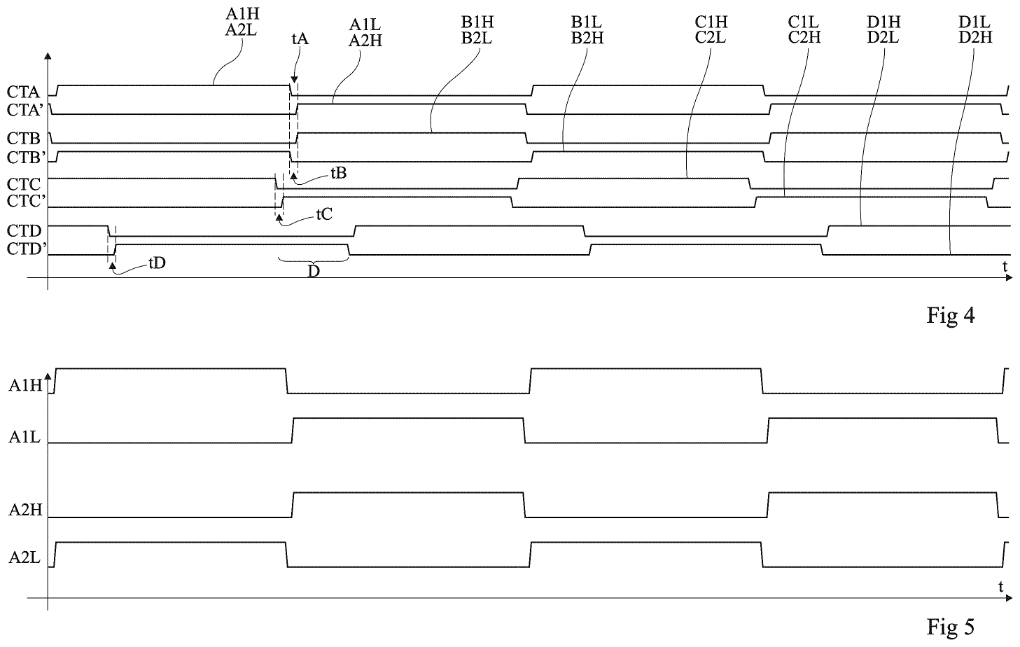

FIGS. 4, 5, 6, 7 and 8 illustrate, in chronogram form, the operation of a conversion system of the type illustrated in FIG. 3.

FIG. 4 illustrates chronograms of example control signals CTA, CTA′, CTB, CTB′, CTC, CTC′, CTD, CTD′, applied to the gates of the transistors of converters DAB1 and DAB2.

The signal CTA is applied to terminals A1H and A2L, and controls transistors K11 and K32. The signal CTA′ is applied to terminals A1L and A2H, and controls transistors K31 and K12. The signal CTB is applied to terminals B1H and B2L, and controls transistors K21 and K42. The signal CTB′ is applied to terminals BIL and B2H, and controls transistors K41 and K22. The signal CTC is applied to terminals C1H and C2L, and controls transistors K51 and K72. The signal CTC′ is applied to terminals C1L and C2H, and controls transistors K71 and K51. The signal CTD is applied to terminals D1H and D2L, and controls transistors K61 and K82. The signal DTA′ is applied to terminals D1L and D2H, and controls transistors K81 and K62.

The signals CTA, CTA′, CTB, CTB′, CTC, CTC′, CTD, CTD′ are digital signals which, when applied to the respective gates of the transistors forming the switches, turn these transistors on when the control signal is in the high state, and turns them off when the signal is in the low state. In this way, the transistors are on/off controlled.

As illustrated by the chronograms in FIG. 4, a slight time offset (tA, tB, tC, tD) is generally provided between the respective rising edges of the control signals of the transistors on the same arm. This is to avoid the risk of simultaneous conduction of transistors on the same arm. The offsets tA, tB, tC, and tD preferably, but not necessarily, all have the same value. Preferably, the duty cycles of the control signals of the same arm are slightly different (a few percent difference). In the example shown, the duty cycle of the signals CTA′, CTB, CTC′, and CTD is lower than that of the respective signals CTA, CTB′, CTC, and CTD′.

FIG. 4 also illustrates an example phase shift D corresponding to the phase shift between the arms C and D of each converter. This phase shift D corresponds to the deliberate phase shift introduced to meet the power demand, in order to preserve efficiency by keeping the control close to zero voltage.

All these phase shifts, duty cycle deviations and time offsets generate common-mode noise in each converter, as in a conventional converter. However, as illustrated in the following figures, the particular combination of both converters and their control signals in the same conversion system means that the common-mode noise of one converter is compensated for by the common-mode noise of the other.

FIG. 5 illustrates chronograms of control signals for one arm of the conversion system shown in FIG. 3.

More specifically, FIG. 5 illustrates the shapes of the control signals A1H, A1L, A2H, and A2L for transistors K11, K21, K112, K22 of the arms A of the converters DAB1 and DAB2, highlighting the identity of the signals A1H and A2L, A1L and A2H respectively.

Although the corresponding shapes have not been illustrated, the same identity is found at the level of each arm, i.e. the control signal of one switch on each arm of a converter is the same as the control signal of the other switch on the same arm (the switch having the opposite position in the arm) of the other converter.

FIG. 6 illustrates chronograms of the respective corresponding voltage shapes across transistors K21 and K22.

As shown in FIG. 6, the drain-source voltages VdsK21 and VdsK22 across the low transistors of the branches A of the converters DAB1 and DAB2 are in phase opposition. Similar shapes are obtained respectively for transistors:
K41 and K42 of the branches B;
K61 and K62 of the branches C; and
K81 and K82 of the branches D.

FIG. 7 illustrates chronograms of the respective shapes of voltages V231 and V232 across the respective windings 231 and 232 of transformer T1 of the first converter DAB1. This figure emphasizes the impact of phase shifting could have on common-mode noise with a single converter. More specifically, this figure emphasizes the voltage variations associated with phase shifts between the switching edges on the arms of the same bridge. These variations result in common-mode currents via parasitic ground connection capacitances.

FIG. 8 illustrates the corresponding chronograms for the second converter DAB2, i.e. the respective shapes of voltages V231 and V232 across windings 241 and 242 of transformer T2 of the second converter DAB2.

Combining FIGS. 7 and 8 shows the compensation achieved thanks to the obtained symmetry between the signals.

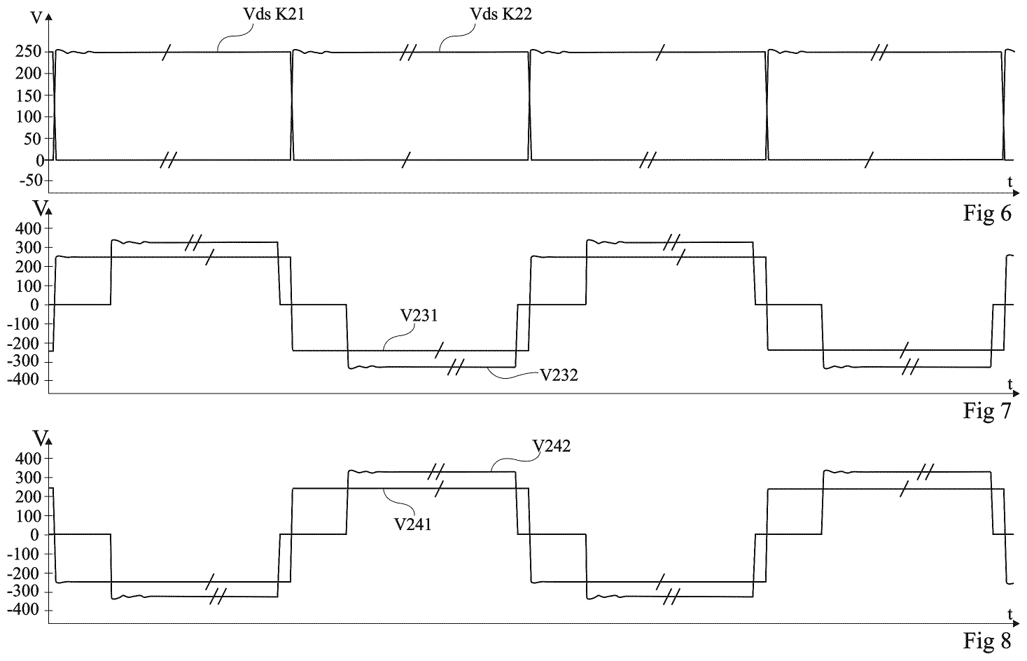

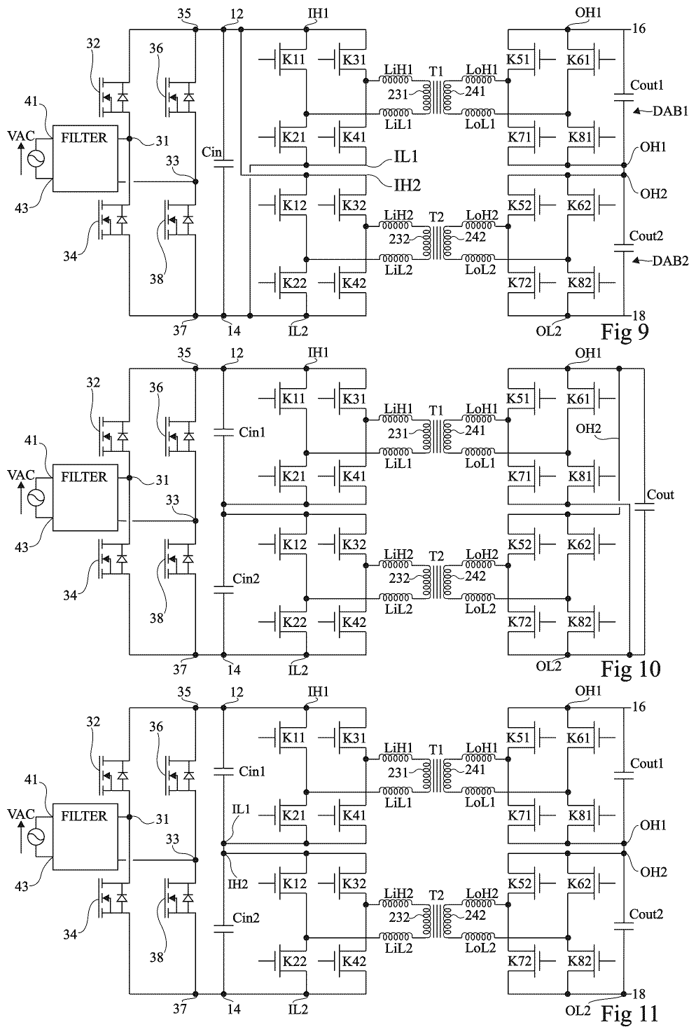

FIG. 9 illustrates an example configuration of the system shown in FIG. 2, in which the input bridges of the converters DAB1 and DAB2 are connected in parallel, and the output bridges are connected in series. For simplicity, the switch sets SIH, SIL, SOH, SOL are not illustrated in FIG. 9.

Compared with the conversion system illustrated in FIG. 3, the low output terminal OL1 of the converter DAB1 is coupled, preferably connected, to the high output terminal OH2 of the converter DAB2. As a result, the capacitors Cout1 and Cout2 are in series between output terminals 16 and 18.

The rest of the conversion system is similar to that shown in FIG. 3.

Compared with the (parallel-parallel) conversion system shown in FIG. 3, the (parallel-serial) system of FIG. 9 provides, with the same component size and input voltage Vin, an output voltage Vout of double value.

As a particular example, for an AC input voltage VAC of 230 volts, we can obtain an output voltage Vout of the order of 800 volts, while having switches sized for voltages of 400 to 600 volts (the input bridge switches only see voltages of the order of 400 volts).

FIG. 10 illustrates an example configuration of the system shown in FIG. 2, in which the input bridges of the converters DAB1 and DAB2 are connected in series, and the output bridges are connected in parallel. For simplicity, the switch sets SIH, SIL, SOH, SOL are not illustrated in FIG. 10.

Compared with the conversion system illustrated in FIG. 3, the low input terminal IL1 of the converter DAB1 is coupled, preferably connected, to the high input terminal OH2 of the converter DAB2. As a result, capacitors Cin1 and Cin2 are connected in series between input terminals 12 and 14.

The rest of the conversion system is similar to that shown in FIG. 3.

FIG. 11 illustrates an example system configuration shown in FIG. 2, in which the input bridges of the converters DAB1 and DAB2 are connected in series, and the output bridges are connected in parallel. For simplicity, the switch sets SIH, SIL, SOH, SOL are not illustrated in FIG. 11.

Compared with the conversion system illustrated in FIG. 9, the low input terminal IL1 of the converter DAB1 is coupled, preferably connected, to the high input terminal OH2 of converter DAB2. As a result, capacitors Cin1 and Cin2 are also connected in series between input terminals 12 and 14.

Controlling the transistors in the various bridges is not affected by the input or output serial or parallel connection mode. One provides always the same signal inversion of one converter with respect to the other, as illustrated in FIG. 2.

So, for a given component size, the converter connection mode depends on the input and output voltage levels.

Preferably, in a practical implementation, the input bridge of one converter should be spatially arranged as close as possible to the output bridge of the other. This allows the impact of parasitic grounding capacitances to be reduced, and current paths to be shortened by limiting magnetic fields due to the current loop via parasitic grounding capacitances.

An example application of the described embodiments concerns battery charging systems for electric vehicles. In such applications, the conversion system has to be capable of adapting the voltage of mains or the alternator of the vehicle to the battery(ies) of the vehicle, and vice versa.

One advantage of the described embodiments is that they provide the benefits of zero voltage switching control while minimizing the common-mode noise generated.

Another advantage of the described embodiments is that they enable the dimensions of common-mode filters for filtering electromagnetic disturbances to be reduced.

Another advantage of the embodiments described is that they allow the switching frequency of switched-mode converters to be increased (e.g. to the order of 400-500 kHz) while preserving common-mode noise compatible with electromagnetic interference standards.

Another advantage of the embodiments described is that they are compatible with control signal generation designed for a conventional dual-active-bridge converter. It is sufficient to apply the control signals to one of the converters and their inverse to the other.

The embodiments described are particularly suitable for using GaN transistors as switches, as they allow the switching frequency, and therefore the efficiency of the conversion system, to be increased. However, they are not limited to this type of transistor, and are also advantageous for converters based on MOSFET or SiC transistors, as they reduce common-mode noise at a given switching frequency.

A dual inverter system with dual active bridges as described can be used not only in single-phase converter applications, but also in three-phase applications.

To implement a three-phase conversion system, three pairs of dual converters are provided, such as the pair illustrated in FIG. 2. The converters are connected in pairs, as would be three converters of the type shown in FIG. 1.

Various embodiments and variants have been described. Those skilled in the art will understand that certain features of these embodiments can be combined and other variants will readily occur to those skilled in the art. In particular, galvanic isolation structures other than transformers may be provided between the two H-bridges of the same converter, for example of a capacitive or piezoelectric nature.

Finally, the practical implementation of the embodiments and variants described herein is within the capabilities of those skilled in the art based on the functional description provided hereinabove, in particular, as regards generating control signals adapted to the described conversion system.

1. A switching power supply system including:
two dual-active-bridge converters;
a first switch set coupling two terminals for applying a first voltage to both input terminals of each converter, or to a single input terminal of each converter respectively;
a second switch set coupling two terminals for supplying a second voltage to both output terminals of each converter, or to a single output terminal of each converter respectively; and
a circuit controlling the switches of the first and second sets,
the switches of the converters being controlled in opposition from one converter to the other.

2. The system according to claim 1, wherein the switches of the second set are controlled according to the desired value of the second voltage.

3. The system according to claim 1, wherein the switches of the first set are controlled as a function of the required power output.

4. The system according to claim 1, wherein:
a first input terminal of the first converter is coupled to a first terminal for applying a first voltage and, via a first switch of the first set, to a first input terminal of the second converter;
a second input terminal of the first converter is coupled, via a second switch of the first set, to the second terminal for applying the first voltage or to the first input terminal of the second converter;
a first output terminal of the first converter is coupled to a first terminal for supplying a second voltage and, via a first switch of the second set, to a first output terminal of the second converter; and
a second output terminal of the first converter is coupled, via a second switch of the second set, to a second terminal supplying the second voltage or to the first output terminal of the second converter.

5. The system according to claim 1, wherein each converter includes:
a first H-bridge including a first and a second parallel arm of two switches in series between the two input terminals of the converter;
a second H-bridge including a third and a fourth parallel arm of two switches in series between the two output terminals of the converter;
a transformer, a first winding of which is coupled to the respective interconnection nodes of the series switches of the first and second arms, and a second winding of which is coupled to the respective interconnection nodes of the series switches of the third and fourth arms.

6. The system according to claim 5, wherein four inductive elements are respectively interposed between each winding end and the interconnection node to which this end is coupled.

7. The system according to claim 6, wherein said inductive elements all have the same value.

8. The system according to claim 5, wherein each H-bridge includes:
a first switch and a second switch in series within the first arm;
a third switch and a fourth switch in series within the second arm;
a fifth switch and a sixth switch in series within the third arm;
a seventh switch and an eighth switch in series within the fourth arm.

9. The system according to claim 8, wherein:
the first switch of each converter is turned conductive, respectively blocked, at the same time as the second switch of the other converter;
the third switch of each converter is turned conductive, respectively blocked, at the same time as the fourth switch of the other converter;
the fifth switch of each converter is turned conductive, respectively blocked, at the same time as the sixth switch of the other converter;
the seventh switch of each converter is turned conductive, respectively blocked, at the same time as the eighth switch of the other converter.

10. The system according to claim 5, wherein the transformer ratio of the transformers of the first and second converters is equal to 1.

11. The system according to claim 1, wherein the switches are HEMT-type transistors in GaN technology.

12. The system according to claim 1, wherein switches are controlled at a switching frequency of several hundred kHz, preferably greater than 400 kHz.

13. The system according to claim 1, including a single pair of converters, and the first voltage is supplied by a circuit for rectifying a single-phase AC voltage.

14. The system according to claim 1, including three pairs of converters, and wherein the first voltage of each converter is extracted based on rectifiying a three-phase AC supply.

15. The system according to claim 1, wherein the second voltage is intended for charging a battery, preferably a motor vehicle battery.
